(19) United States
(12) Patent Application Publication
(10) Pub. No.: US 2006/0232570 A1
(43) Pub. Date: Oct. 19, 2006

(54) Signaling pen

(75) Inventors: Ki Sheung Yuen, Brampton (CA); Xiaoyu Zhou, Maple (CA); Jonathan David Liberty, Toronto (CA)

Correspondence Address: Dennison Associates, Suite 301, 133 Richmond Street West, Toronto, M5H 2L7, CA

(73) Assignee: Ingenico Canada Ltd.

(21) Appl. No.: 11/178,300

(22) Filed: Jul. 12, 2005

(30) Foreign Application Priority Data
Apr. 19, 2005 (CA) 2,503,204

(51) Int. Cl. G09G 5/00

(52) U.S. Cl. 345/179

(57) ABSTRACT

A signaling pen of improved construction includes an actuator that functions generally independent of a bias and stop arrangement. Preferably an antenna is fixed to a PCB board secured within a body. This provides an efficient signal communication path. Preferably the PCB board is secured within an inner casing that also houses the ON/OFF actuator. An extension of the displaceable pen tip extends into said casing and controls the ON/OFF actuator.

### FIELD OF THE INVENTION

The present invention relates to a digital pen for use in association with a digitizing surface.

### BACKGROUND OF THE INVENTION

An electronic signaling device in the form of a pen or stylus has been used for many years in association with a digitizing surface. Basically, the stylus cooperates with the digitizing surface to determine the particular pattern of movement of the pen as it moves across the surface and provides a digital record thereof. These types of devices are used for a host of applications but have particular application in association with check writing and/or digital signatures.

The technology for using a digital pen is quite well known and requires a user to place the pen on the appropriate surface and displaces a tip portion to activate the device as part of the normal writing process. The pen transmits or receives a signal depending on the particular application and in any event, the particular position of the pen on the surface is determined. As the pen is moved across the surface, the particular pattern is recorded and typically visually reproduced on the device.

Although digital pens have been known for many years, the construction of the pens is complicated and the assembly of the components of the pen requires considerable precision and time.

The present invention provides a simplified electronic pen which is cost effective to manufacture.

### SUMMARY OF THE INVENTION

An electronic signaling pen according to the present invention comprises an antenna and a pen tip movable relative to a casing which secures a printed circuit board (PCB). The pen tip is movable between an OFF position and an ON position with a spring bias urging the pen tip to the OFF position. The pen tip includes an actuator independent of the antenna that cooperates with a contact point of a circuit of the PCB board and changes the state of the circuit dependent upon the position of the pen tip in the ON or OFF position. The pen tip includes a stop arrangement that limits the extent that the tip moves towards the casing.

According to an aspect of the invention, the PCB board includes an antenna fixed to the PCB board.

According to a further aspect of the invention the pen tip moves relative to the antenna as the pen tip moves between the OFF position and the ON position.

In yet a further aspect of the invention, the movement of the pen tip between the ON and OFF positions is less than 1 mm.

In yet a further aspect of the invention, the actuator includes compressible material secured on an end portion of the pen tip.

In yet a further aspect of the invention, the compressible material includes an electrical conducting portion at a free end thereof that engages and completes an electrical condition with the PCB board when the pen tip is in the ON position.

In a different aspect of the invention, the pen includes an outer protective sleeve about the casing of the pen and the pin tip is movable relative to the outer protective sleeve.

In yet a different aspect of the invention, the signaling pen has a split plastic molded casing about the circuit board and secures the circuit board. This plastic mold casing is plated with an electrically conducted material and includes a ground arrangement for grounding of the PCB board.

In yet a different aspect of the invention, the casing adjacent the pen tip includes a port extending through the casing and the pen tip includes an extension member connected to the pen tip and extending into the casing. The extension member includes a compressible switch actuator engaging the PCB board when the pen tip is in the ON position.

An electronic pen according to the present invention comprises a pen body, an electronic circuit secured in the body with the electronic circuit including a stationary part of an ON/OFF actuator. A movable pen tip is secured at one end of the body and is spring biased to an extended position relative to the pen body. The pen tip is movable to an actuating position partially telescoped within the pen body. The pen body includes a moving part of the ON/OFF actuator. This moving part includes an electrical conducting member that forms an electrical connection with the stationary part turning the actuator ON when the pen tip is in the actuating position. The moving part breaks any electrical connection with the stationary part as the pen tip moves from the actuating position to the extended position. The electronic circuit includes antenna preferably having a fixed connection with the electronic circuit.

According to an aspect of the invention, the moving part of the actuator is a compressible member fixed on the pen tip interior to the pen body.

In a different aspect of the invention, the pen tip cooperates with a structural element of the pen body to provide a stop surface defining the actuating position.

In a different aspect of the invention, the pen includes a stop surface separate from said ON/OFF actuator that defines said actuating position.

### BRIEF DESCRIPTION OF THE DRAWINGS

Preferred embodiments of the invention are shown in the drawings, wherein:

FIG. 1 is a partial perspective cutaway view of the electronic pen;

FIG. 2 is a sectional view through the electronic pen;

FIG. 3 is a partial sectional view showing the cooperation of the movable pen tip and pen body;

FIG. 4 is a sectional view similar to FIG. 2 but with the pen tip in an actuating position;

FIG. 5 is a partial sectional view showing the pen tip in the actuating position;

FIG. 6 is an exploded view showing the various components of the electronic pen;

FIG. 7 is a partial perspective view of pen tip and pen body; and

FIG. 8 is a partial perspective view of the pen casings.

### DETAILED DESCRIPTION OF THE PREFERRED EMBODIMENTS

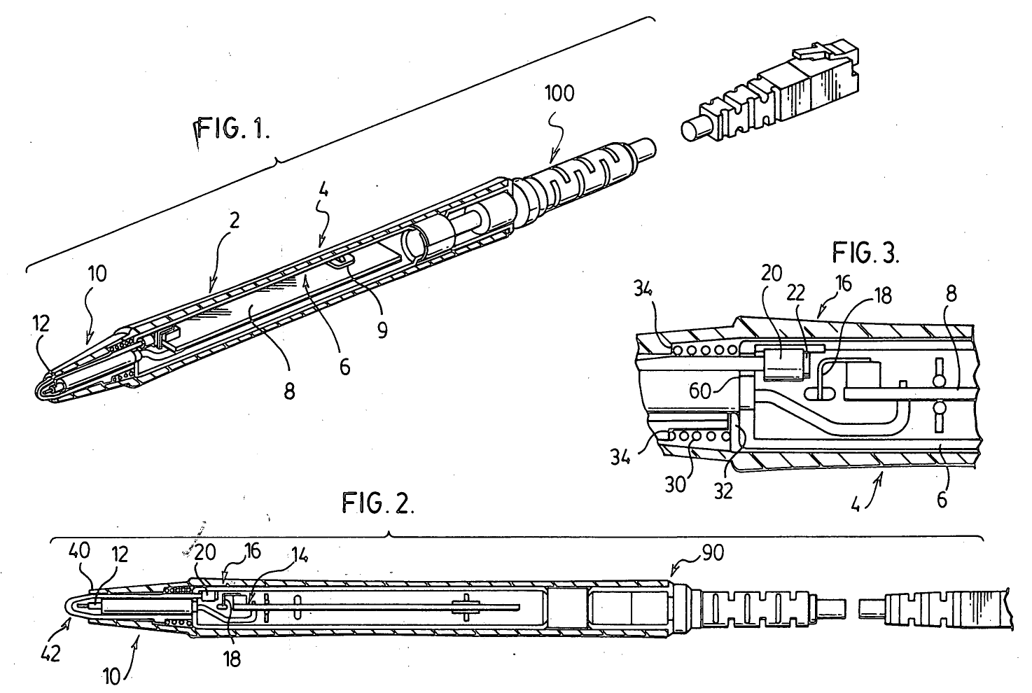

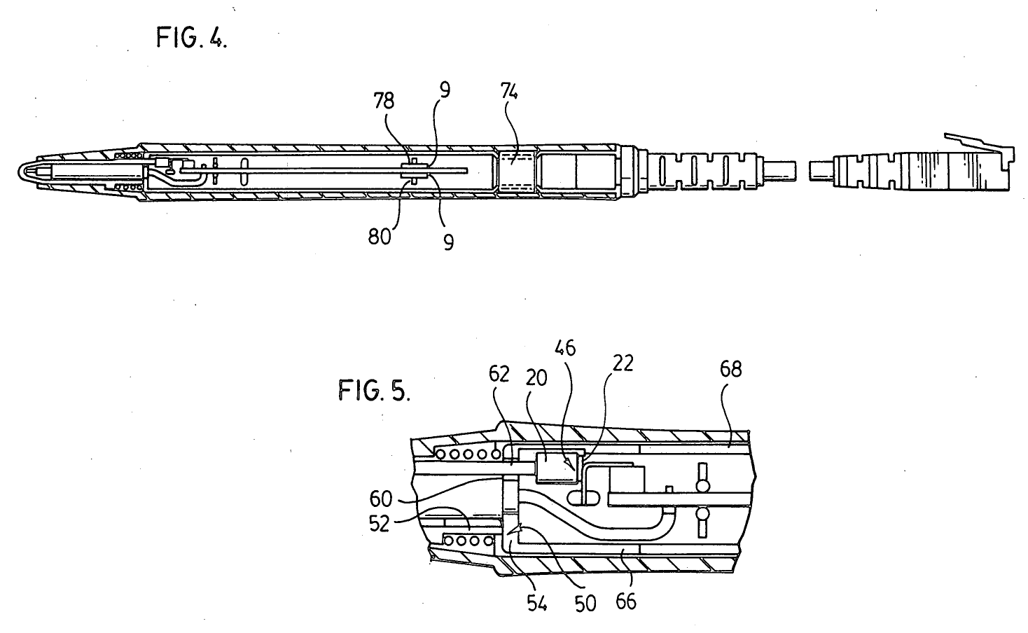

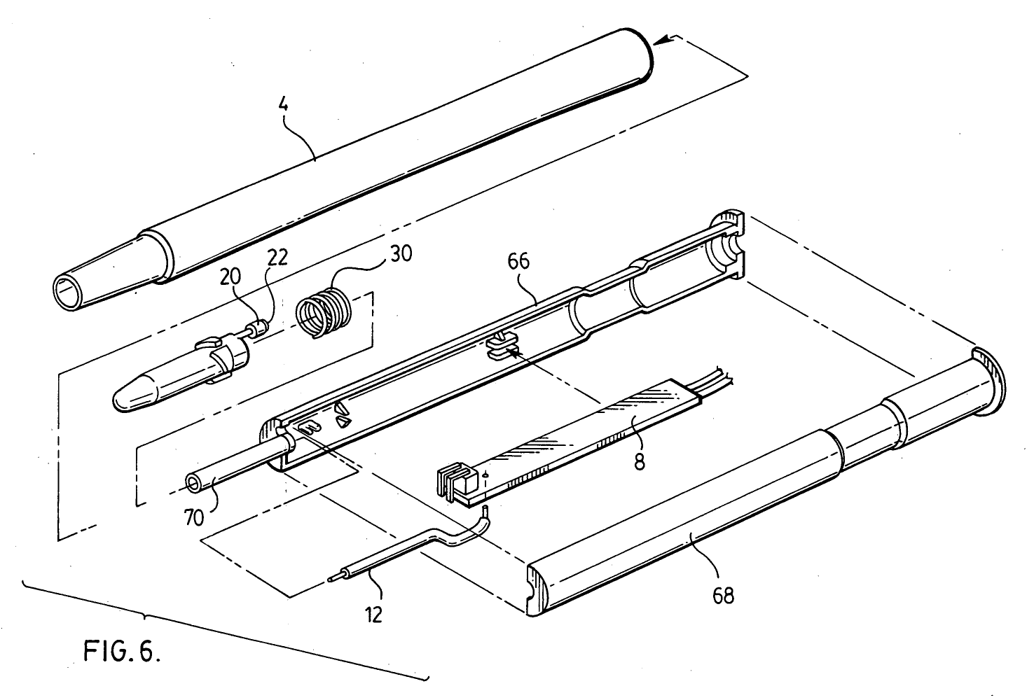

The electrical pen 2 includes an outer pen body 4 housing an inner casing 6. The inner casing is positioned within the outer pen body by guides and houses the PCB circuit board 8. The displaceable tip 10 telescopes within the outer pen body 4 and moves between an extended position as shown in FIGS. 1 and 3 to an actuating position or ON position as shown in FIGS. 4 and 5.

The displaceable tip 10 protects the fixed antenna 12. Preferably the antenna is a wire soldered on the PCB circuit board 8. This provides an effective electrical connection of the antenna 12 to the PCB board. Other electrical connections of the antenna to the PCB board are possible, however, it is preferred that the antenna be fixed on the board to provide an effective signal path. There is no movement of the antenna relative to the PCB board during movement of the displaceable tip 10 from the extended position to the actuating position. In a preferred embodiment the wire antenna is a conventional wire. For example, 24 awg wire performs well.

The displaceable tip 10 is preferably an injection molded plastic member and carries a movable part 20 of the ON/OFF actuator 16. The PCB board 8 includes a stationary part defined by two spaced conductors 18 which cooperate with the electrical conducting surface 22 of the movable part 20. As the pen tip moves from the extended position of FIG. 1 to the actuating position of FIGS. 4 and 5, the movable part 20 which is a compressible member moves with the pen tip and applies a low pressure force on the two spaced conductors 18 due to compression of the movable member. The resilient compression of member 20 provides an efficient connection of the electrical conducting surface 22 with the electrical conductors 18 of the ON/OFF actuator 16.

With the present design, the movable part 20 undergoes compression and thus a pressure force is exerted to provide an effective connection of the two electrical connectors 18 of the stationary part of the actuator 16. Compressible member 20 does not significantly act to stop the movement of the displaceable tip 10. This movement is stopped due to an interference contact between the displaceable tip 10 and in this case, the end of the inner casing 6. The bias spring 30 produces a force much greater (at least an order of magnitude greater) than the compression force generated by member 30. Thus the resilient compression force of member 30 does not significantly influence the bias force of the spring.

As shown in FIG. 5, extension 52 of the pen tip bottoms against the end 54 of the casing 8. The bias spring 30 provides some resistance, however, it is the engagement of extension 52 and 54 of the casing that provides the positive stop and determines the actuating position of the pen tip. When pressure on the pen tip is removed, i.e. the pen tip is not in writing contact with a surface, the bias spring 30 forces the displaceable pen tip 10 to the extended position as shown in FIGS. 1, 2 and 3.

As shown in the partial sectional view of FIG. 3, electrical conducting surface 22 of the movable part 20 is now spaced from the electrical conductors 18 of the stationary part of the ON/OFF actuator 16.

The inner casing 6 includes a first casing 66 and a second casing 68 and these casings include a port 60 through which the projecting arm 62 of the pen tip 10 extends. With this arrangement, the movable part 20 is located within the casing 6 and is quickly actuated by means of the movement of the pen tip to the actuating position. It can also be appreciated that the antenna 12 is stationary and includes an excellent electrical connection with the PCB board 8.

As shown in FIG. 6, the first casing 66 includes a guide tube 70 which is sized to receive the antenna 12. The antenna is secured on the PCB board 8 and is then located together with the PCB board between the two casings. The first casing 66 and the second casing 68 cooperate to positively secure the PCB board 8 in a fixed position within the casing. Each of the casings 66 and 68 are a plastic molded component that is electrically plated with a conductive metal. The PCB extends across the two casings such that the split lines are above and below the PCB board. The metal plated casings act as a shield electrically protecting the PCB board from extraneous signals. Only the portion of the antenna beyond the casing is outside the shield whereby improved performance is achieved.

The casings cooperate, as shown in FIGS. 2 and 4, where the grounding flanges 78 and 80 of the casings engage appropriate electrical contact portions 9 on the PCB board 8. This provides a common voltage reference to the PCB board and the assembled casing. A ground sleeve 74 is then applied over the metal plating of the casings (see FIG. 8).

The PCB board 8 and the casings are assembled in a simple manner and the displaceable tip 12 is also assembled on the casings. This is required as the movable compressible part 20 is located within the casing. Therefore, the displaceable tip 10, the spring 30 and the movable part 20 are assembled on the cooperating first and second casings 66 and 68. Once this arrangement has been assembled, it can then be inserted into the open end 90 of the outer body pen portion 4. The inner casing 6 is moved to the bottom end of the outer pen body 4 until it engages a stop or locating flange such as flange 32. The spring relief provided by the rubber portion of the electrical conductor 100 closes the end of the pen body and locks the casing 6 in position.

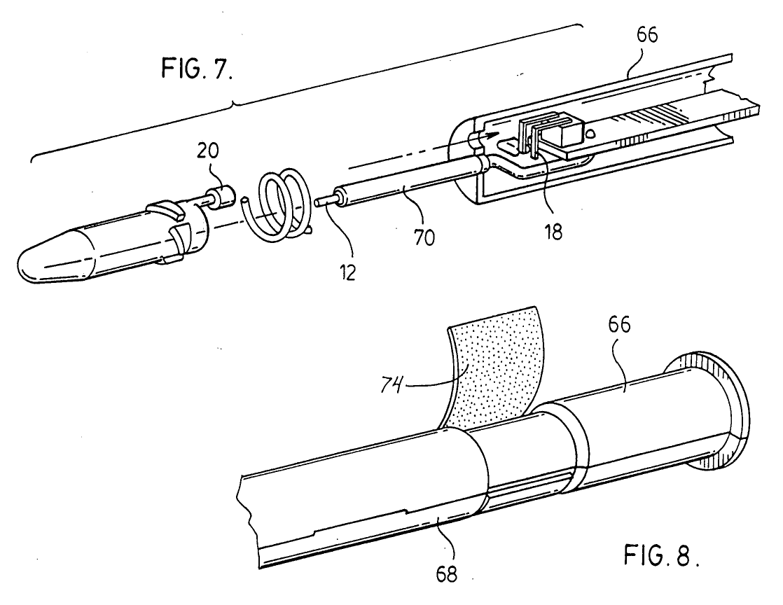

The general assembly of the pen is as follows: The electrical power conductor 100 and the antenna 12 are soldered to the PCB board. The PCB board is then positioned in the casing 66 and the antenna is placed in the tube 70 (see FIG. 7). A bare portion of the antenna extends beyond the casing. The pen tip and actuator are assembled on the casing 66. The other casing 68 is then assembled to enclose the PCB board. The assembled unit is inserted into the pen body and locks therewith.

The metal plate casing and PCB board are grounded when the pen is actuated and a sinusoidal signal is provided to the casing when the pen is not actuated.

This particular arrangement has proven to be effective partially due to the effective electrical connection of the antenna to the PCB board as well as the action of ON/OFF actuator 16 that operates essentially independently of a stop mechanism. The number of moving parts has been reduced and the ability to provide high quality control is realized. The ON/OFF actuator and the pen tip operate quickly without any large movement of the displaceable pen tip. This improves the feel of the pen to a user.

Although various preferred embodiments of the present invention have been described herein in detail, it will be appreciated by those skilled in the art that variations may be made thereto without departing from the spirit of the invention or the scope of the appended claims.

The embodiments of the invention in which an exclusive property or privilege is claimed are defined as follows:

1. An electronic signaling pen comprising an antenna,
a pen tip movable relative to a casing between an OFF position and an ON position with a spring bias urging said pen tip to said OFF position, said casing including a PCB board secured therein,
said pen tip including an actuator that cooperates with an actuation point of a circuit of said PCB board and changes the state of said circuit dependent upon the ON/OFF position of said pen tip, said actuator in said ON position causing said circuit to conduct and in said OFF position, causing said circuit to be open; and wherein said pen tip includes a separate stop arrangement that determines the ON position of said pen tip.

2. An electronic signaling pen as claimed in claim 1 wherein said PCB board includes an antenna fixed to said PCB board.

3. An electronic signaling pen as claimed in claim 2 wherein said pen tip moves relative to said antenna as said pen tip moves between said OFF position to the ON position.

4. An electronic signaling pen as claimed in claim 3 wherein the movement of said pen tip between the ON and OFF positions is less than 1 mm.

5. An electronic signaling pen as claimed in claim 1 wherein said actuator is a compressible member secured on an end portion of said pen tip.

6. An electronic signaling pen as claimed in claim 5 wherein said compressible member includes an electrical conducting portion at a free end thereof that completes an electrical connection with said actuation point PCB board when said pen tip is in said ON position.

7. An electronic signaling pen as claimed in claim 1 including an outer protective sleeve about said casing with said pen tip movable relative to said outer protective sleeve.

8. An electronic signaling pen as claimed in claim 7 wherein said casing is a split plastic molded casing.

9. An electronic signaling pen as claimed in claim 8 wherein said split plastic molded casing is plated with an electrically conductive material and includes a ground arrangement for grounding said PCB board.

10. An electronic signaling pen as claimed in claim 9 wherein said casing adjacent said pen tip includes a port extending through said casing and said pen tip includes an extension member connected to said pen tip and extending into said casing, said extension member including a compressible switch actuator engaging said actuation point of said PCB board when said pen tip is in the ON position.

11. An electronic signaling pen as claimed in claim 10 wherein said compressible switch actuator includes an integral electrically conducting member at the end thereof that engages stationary electrical conducting points of said actuation point and completes an electrical conduction path of said circuit.

12. An electronic signaling pen as claimed in claim 11 wherein said pen tip when assembled on said casing is captured thereon.

13. An electronic signaling pen as claimed in claim 12 wherein said compressible switch actuator is resiliently compressed as said pen tip moves between said OFF and said ON positions.

14. An electronic signaling pen as claimed in claim 13 wherein said molded casing includes an antenna sleeve projecting from one end of said casing into said pen tip.

15. An electronic signaling pen as claimed in claim 14 wherein said antenna is a wire soldered to said PCB board.

16. An electronic signaling pen as claimed in claim 1 wherein said antenna is a wire soldered to said PCB board.

17. An electronic pen comprising a pen body, an electronic circuit secured in said pen body and said electronic circuit includes a stationary part of an ON/OFF actuator, a movable pen tip secured at one end of said body that is spring biased to an extended position relative to said pen body and is movable to an actuating position partially telescoped within said pen body, said pen tip including a moving part of said ON/OFF actuator, said moving part including an electrical conducting member that forms an electrical connection with said stationary part turning said actuator ON when said pen tip is in said actuating position, said moving part breaking any electrical connection with said stationary part as said pen tip moves from said actuating position to said extended position and thereby turning said actuator OFF when said pen tip is in said extended position, and wherein said electronic circuit includes an antenna having a fixed connection with said electronic circuit.

18. An electronic pen as claimed in claim 17 wherein said moving part of said actuator is a compressible member fixed on said pen tip interior to said pen body.

19. An electronic pen as claimed in claim 18 wherein said pen tip cooperates with a structural element of said pen body to provide a stop surface defining said actuating position.

20. An electronic pen as claimed in claim 17 wherein said pen includes a stop surface separate from said ON/OFF actuator, said stop face determining the extent that said pen tip can telescope within said pen body.

21. An electronic pen comprising a pen body, an electronic circuit secured in said body and said electronic circuit including a stationary part of an ON/OFF actuator, a movable pen tip secured at one end of said body that is spring biased to an extended position relative to said pen body and is movable to an actuating position partially telescoped within said pen body, said pen tip including an moving part of said ON/OFF actuator, said moving part including an electrical conducting member that forms a first electrical state with said stationary part turning said actuator ON when said pen tip is in said actuating position, said moving part changing said first state to a second electrical state turning said actuator OFF as said pen tip moves from said actuating position to said extended position, and wherein said electronic circuit includes an antenna having a fixed connection with said electronic circuit.

22. An electronic pen as claimed in claim 21 wherein said moving part of said actuator is a compressible member fixed on said pen tip on a portion of said pen tip extending into an interior chamber portion of said pen body that houses said electronic circuit.

23. An electronic pen as claimed in claim 22 wherein said pen tip cooperates with a structural element of said pen body to provide a stop surface defining said actuating position that limits the inward telescopic movement of said pen tip.

24. An electronic pen as claimed in claim 21 wherein said pen includes a stop surface separate from said ON/OFF actuator.

25. An electronic pen as claimed in claim 22 wherein said spring bias in said ON position generates a force at least a order of magnitude greater than a force generated due to compression of said compressible member when said actuator is in said ON position.
